(19) United States
(12) Patent Application Publication
(10) Pub. No.: US 2004/0047154 A1
(43) Pub. Date: Mar. 11, 2004

(54) Tracklight system

(76) Inventors: Jack V. Miller, Seaford (DE); Ruth E. Miller, Seaford (DE)

Correspondence Address: Jack V. Miller, 20915 Sussex Hwy 13, SEAFORD, 19973, DE

(21) Appl. No.: 10/656,718

(22) Filed: Sep. 8, 2003

Related U.S. Application Data
(63) Continuation-in-part of application No. 09/639,401, filed on Aug. 15, 2000, now abandoned.

(51) Int. Cl. F21V 1/00

(52) U.S. Cl. 362/285

(57) ABSTRACT

A tracklight includes an elongated tube having a proximal end and a distal end and including a reflector, a lens and a diffuser extending along the length of the tube. The tube has angular reflector portions proximally joined at an apex on an optical axis of symmetry. said angular portions having distal edges connecting the reflector, lens and diffuser. One or more light sources are positionable along the length of the tube between the reflector and the lens, emitting light through the lens and diffuser, generally perpendicular to the length of the tube. Preferred embodiments include square, rectangular and circular cross-sectional shapes, any of which which may have means for attachment to mounting surfaces including inverted T-bar ceiling runners.

### BACKGROUND

1. Field Of The Invention

This invention is a continuation-in-part of application Ser. No. 09/639,401. The present invention relates to the field of tracklight systems having elongated tracks provided with light sources that are positionable along the length of the track. Where long lengths of track are needed, several sections of track may be joined together. The primary advantage of tracklight systems over fixed-location lighting fixtures is the flexibility that permits light sources to be moved along the track to where illumination is needed, particularly when displays are changed. In many retail and museum display lighting systems, tracks are parallel to and spaced a distance from the walls, serving as wallwasher luminaires to illuminate both graphics and objects on the walls, on wallmounted shelves, or on counters along the walls.

2. Description Of Prior Art

Most tracklight systems available today are ceiling mounted, generally U-shaped tracks, supporting and energizing incandescent or compact fluorescent downlights with reflectors that aim the light towards areas or objects to be illuminated. The result is usually an irregular light patterns on artifacts, forming irregular scalloping on a nearby wall. In order to avoid the scalloping, it is typical to install a number of closely-spaced light fixtures, as shown in the applicant's U.S. Pat. No. 4,822,292 Multiple line Circuit Track Lighting Systerm The result is a cluttered appearance from the depending track luminaires, along with a substantial amount of heat from the illumination. This type of tracklight system is also virtually incapable of producing smooth, uniform light distribution, but instead produces spaced pools of light on a floor, or scallops of light in a wall.

The visual clutter of depending luminaires has been eliminated with low-profile tracklight systems illustrated by the applicant's U.S. Pat. No. 6,439,749 Internal Fixture Track Lighting System and U.S. Pat. No. 6,409,524 Side-Mounted Tracklight System in which the luminaires may be operated within the track. It was also found that the heat from the illumination can be eliminated by employing fiber optic luminaires, as shown in the applicant's U.S. Pat. No. 5,325,272 Fiber Optic Track Lighting System and D.405,898 Intemally-Illuminated Lighting Track, in which discrete, aimable fiber-optic luminaires are spaced apart and hidden inside the track to emit light wherever it is needed. These fiber optic tracklight systems can provide 32 individual luminaires with the light projector feeding the 32 fibers being remotely located in an accessible service area that facilitates relamping and maintenance of the projectors.

Although the above-described tracklight systems all represent dramatic improvements in the state of the art, there is still a continuing need for an even lower profile, low-cost tracklight system, without a clutter of depending luminaires, with easily-accessed remote relamping, and in which a uniform light pattern can be produced without the need for any track luminaires.

### PURPOSES OF THE INVENTION

The primary purpose of the present invention is to provide a low-proffle tracklight system, without the clutter of depending luminaires, that provides a smooth light distribution without scallops or discontinuities. It is a further purpose of the invention to provide a low cost tracklight system with the ability to position and relocate the light sources as needed.

### BRIEF DESCRIPTION OF THE INVENTION

The foregoing purposes of the present invention are achieved by a tracklight system including an elongated, tubular track of constant cross-sectional shape. The track has a proximal end and a distal end, a light reflector and a light diffuser extend along the length of the track and form a tube. An elongated lens extends through the length of the tube and divides the reflector from the diffuser.

An elongated source of illumination is disposed between the reflector and the lens, emitting light generally perpendicular to the length of the tube. The light source may be an array of incandescent or fluorescent lamps or light-emitting diodes. The light source may also be one or more side-emitting optical fibers or an array of end-emitting optical fibers receiving light from an external source of illumination and emitting light through spaced ends at selected locations along the track. The selected light source may be inserted through the proximal end of the tube, the distal end, from both ends and extending towards the middle, or from the middle and extending towards both ends.

Embodiments of the tubular cross section may be nearly any geometric shape with a relatively low profile that visually blends in with architectural elements such as cornices, reveals, decorative moldings or inverted T-Bar ceiling runners. A first preferred embodiment described in detail herein is a 1-inch square cross section that has proven in practice to be well suited for low-proffle tracklight applications. A second preferred embodiment is a rectangular cross-sectional shape that may be mounted in either vertical or horizontal orientations. A third preferred embodiment is a generally circular cross section. The preferred embodiments may be mounted under shelves, inside display cases, or to suspended-ceiling T-bars without interfering with depending tegular ceiling panels.

### BRIEF DESCRIPTION OF THE DRAWINGS

FIG. 1 is a perspective view of a preferred embodiment of the tracklight according to the invention, having a square cross sectional shape;

FIG. 2 is an enlarged transverse cross-sectional view of the preferred embodiment of FIG. 1, showing light ray paths for asymmetric light distribution with a prismatic lens biasing light away from the center of an optical plane including a symmetric Cl (centerline).

FIG. 3 is a longitudinal cross-sectional view of the preferred embodiment of FIG. 1, showing 90° end-emitting optical fibers as light sources.

FIG. 4 is a longitudinal cross-sectional view of the preferred embodiment of FIG. 1, showing conical-end or side-emitting optical fibers or elongated lamps or arrays of lamps such as incandescent or fluorescent sources.

FIG. 5 is a transverse cross-sectional view of the preferred embodiment of FIG. 1, having a symmetric light distribution about the plane of a symmetric Cl (centerline).

FIG. 6 is a longitudinal cross-sectional view of the tracklight system of FIG. 1, having an downward-biased asymmetric light distribution from the plane of the symmetric Cl.

FIG. 7 is a longitudinal cross-sectional view of the tracklight system of FIG. 1, having an upward-biased asymmetric light distribution from the plane of the symmetric Cl.

FIG. 8 is a transverse cross-sectional view of a second, generally circular embodiment of the invention, having a circular cross-section and a symmetrical light distribution about the plane of the symmetric Cl.

FIG. 9 is a transverse cross-sectional view of the second preferred embodiment of the invention, having an asymmetric light distribution from the center of the plane of the symmetric Cl.

FIG. 10 is a transverse cross-sectional view of a third, preferred, rectangular embodiment of the invention having an asymmetric light distribution.

FIG. 11 is a view of the circular tracklight of FIG. 9, shown attached to a suspended ceiling inverted T-bar.

FIG. 12 is a view of the rectangular tracklight of FIG. 10, shown attached to a suspended ceiling T-bar.

FIG. 13 is optional longitudinal photometric distributions of a tracklight according to the invention.

### REFERENCE NUMERALS IN THE DRAWINGS

1 first preferred embodiment (square cross section)

2 elongated tube

3p proximal end

3d distal end

4 reflector

4a first reflector angular portion

4b second reflector angular portion

4c edge of reflector

5 diffuser

5a first diffuser portion

5b second diffuser portion

5c corner of diffuser

6 apex of symmetric plane

7 lens

7a lens prisms

8 source of illumination

8a side-emitting light source

8b diagonal end-emitting fiber optic

8c conical end fiber optic

10 light-diffusing pattern

11 second preferred embodiment (circular cross section)

12 direct light rays

12b biased light rays

12d diffuse light rays

12r reflected light rays

14 arcuate reflector

15 arcuate diffuser

16 apex of arcuate reflector

17 lens (circular embodiment)

17a linear prisms (circular embodiment)

19 T-bar attachment bracket (circular embodiment)

19a inward flanges of bracket 19

20 inverted T-bar ceiling runner

21 third preferred embodiment (rectangular cross section)

22 elongated tube (rectangular cross section)

24 reflector (rectangular cross section)

25 diffuser (rectangular cross section)

27 lens (rectangular cross section)

27a linear prisms (rectangular cross section)

29 T-bar attachment means (rectangular embodiment)

29a inward flanges of bracket 29

32 elongated tube (rectangular cross section)

41 photometry (uniform illumination)

42 photometry (higher intensity in the center)

43 photometry (higher intensity at the ends)

44 photometry (higher intensity at one end)

### DETAILED DESCRIPTION OF THE DRAWINGS

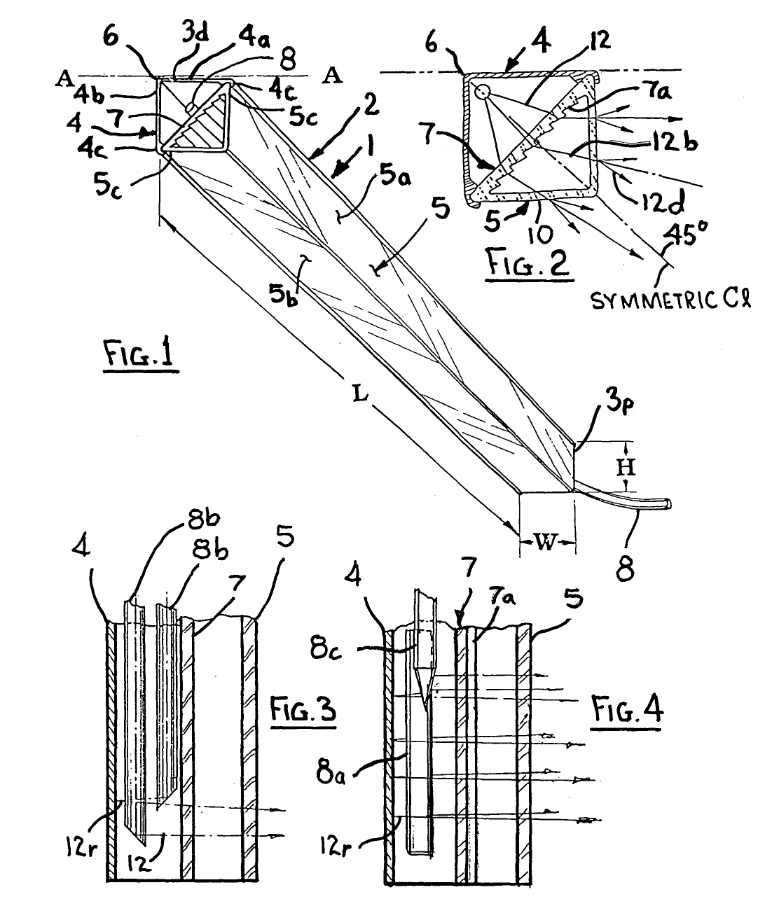

In FIG. 1 a first preferred embodiment of a tracklight system 1 according to the invention is shown having an elongated tube 2 with a proximal end 3 and a distal end 4, mounted on a ceiling plane A-A. The overall dimensions can vary widely, but experience has shown the length “L” of 4 to 8 feet is convenient as a module that can be installed in end-to-end arrangements. The height “H” and width “W” can be of nearly any size, but they work well as 1-inch dimensions that are easy to hide in a reveal or behind a small molding. A 1-inch width also matches the width of the horizontal flange of an inverted T-bar ceiling runner. These convenient small dimensions will readily accommodate a variety of light sources 8. Tube 2 is comprised of a light-reflector 4 comprised first angular portion 4a and second angular portion 4b that are joined at an apex 6 and extend to edges 4c; and a diffuser 5, comprised of first portions 5a and second portion 5b, extending along its length. Diffuser 5 has edges 5c engaged with edges 4c of reflector 4. A lens 7 extends between diffuser edges 4c, separating reflector 4 from diffuser 5 and providing a space for an elongated source of illumination 8.

Illumination source 8 extends from proximal end 3 substantially along the length of the tube, between reflector 4 and lens 7. Illumination source 8 can be one or more optical fibers. Alternatively small diameter T-2 or T-4 fluorescent lamps or a row of small incandescent lamps or Light-Emitting Diodes may be used (such conventional sources are not shown in detail) and energized from a remote power source (also not shown).

In FIG. 2 the first preferred embodiment of tracklightl of FIG. 1 is shown in cross section, with tube 2 having reflector 4, diffuser 5, with lens 7 dividing reflector 4 from diffuser 5. Lens 7 is shown as a linear Fresnel lens with wedge-shaped prisms 7a biasing transverse light with respect to the 45° plane of a symmetric Cl. Diffuser 5 and lens 7 are shown as a single clear plastic extrusion, but could as well be separate parts in a glued or snap-together assembly. The source of illumination 8 emits direct light rays 12 through lens 7, exiting as biased light 12b, which then passes through diffuser 5, including light diffusing pattern 10, as biased, diffused light rays 12d. Lens 7 may also be textured to further diffuse the emitted light.

In FIG. 3 the preferred embodiment of FIG. 1 is shown in a longitudinal cross section in which light source 8b is one or more end-emitting optical fibers having ends cut at an angle to emit light perpendicular to the fiber. In practice, it does not matter which way the angle faces, as by definition the light must either reflect from reflector 4 as reflected rays 12r or refract through lens 7 as biased rays 12b and then pass through diffuser 5 as diffused rays 12d.

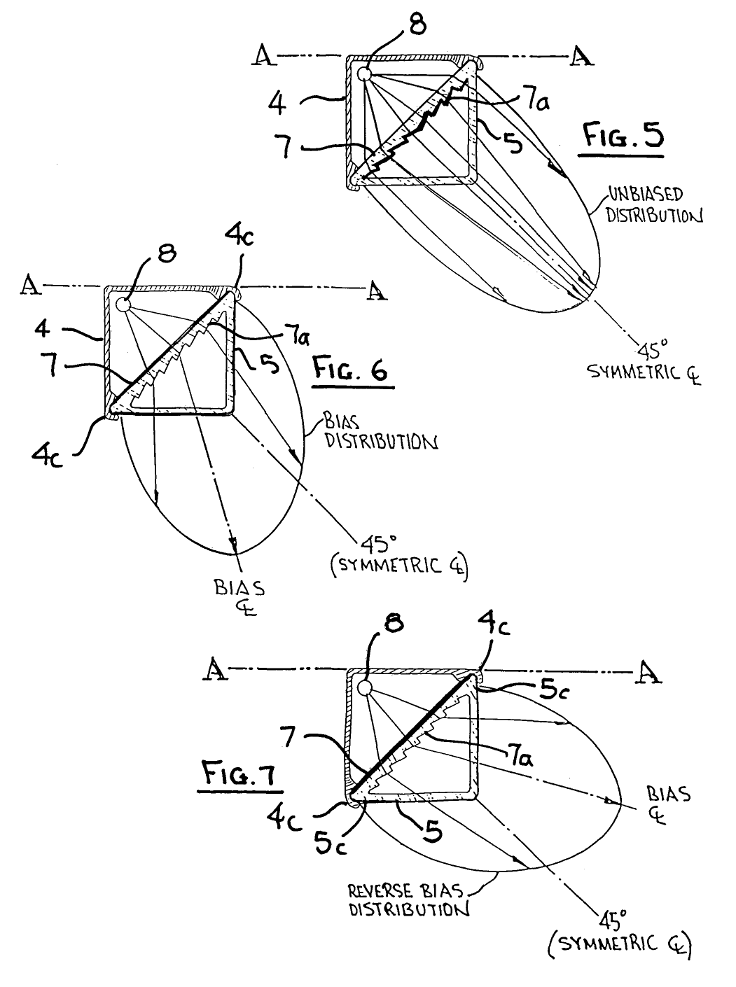

In FIG. 4 the preferred embodiment of FIG. 1 is shown in a longitudinal cross section in which light source 8 may be one or more conical end-emitting optical fibers 8c. Light source 8a may be any side-emitting source, such as side-emitting optical fiber or side-emitting fluorescent, incandescent or LED lamps arrays.

In FIG. 5 a preferred embodiment of FIG. 1 is shown having a Fresnel lens biasing light rays parallel to and towards the 45° plane of symmetric Cl to produce a narrow unbiased and at least partially collimated beam distribution.

In FIG. 6 a preferred embodiment of FIG. 1 is shown with the lens and diffuser engaged into reflector edges 4c, whereby the linear prisms 7a of lens 7 bias light downward from the 45° plane of the symmetric Cl.

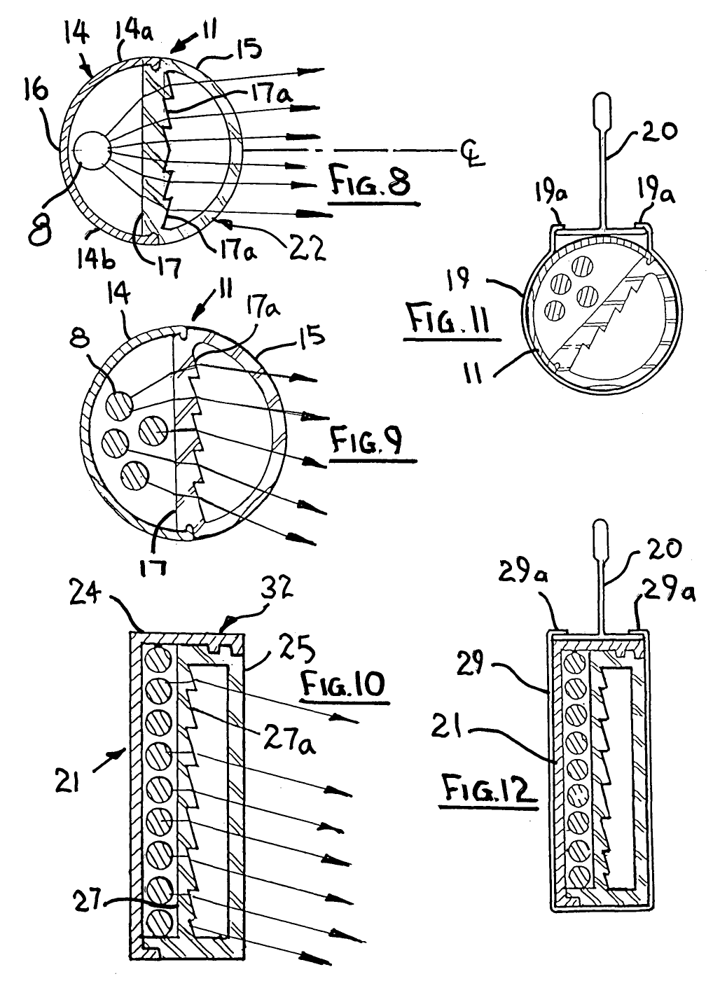

In FIG. 7 a preferred embodiment of FIG. 1 is shown with the lens and diffuser reversed from the position shown in FIG. 6, whereby the linear prisms 7a of lens 7 lens bias light upward from the 45° plane of the symmetric Cl.

In FIG. 8 a second preferred embodiment 11 of the invention is shown having a generally circular cross section tube 22, with an arcuate reflector 14 having portions 14a and 14b disposed about an apex 16 proximate to light source 8. Lens 17 is provided with linear prisms 17a biasing light generally parallel to and collimated towards the plane of the symmetric Cl.

In FIG. 9 the second preferred embodiment 11 of the invention having a generally circular cross section including reflector 14 and diffuser 15 separated by lens 17. Linear prisms 17a of lens 17 bias light downward, away from the plane of the symmetric Cl.

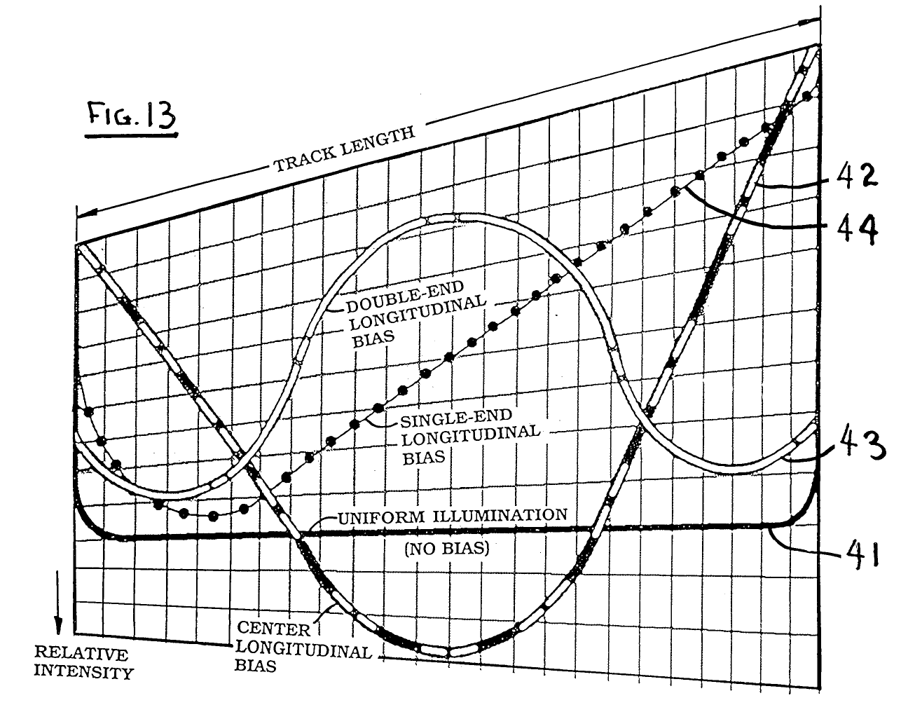

In FIG. 10 a third preferred embodiment 21 of the invention is shown having a rectangular cross section tube 32 including reflector 24 and diffuser 25 separated by lens 27. Linear prisms 27a of lens 27 bias light downward, away from the plane of the symmetric Cl.

In FIG. 11 the second preferred embodiment 11 of the invention having a circular cross section is shown having T-bar attachment means 19 supporting the track from an inverted T-bar ceiling runner 20. The attachment means is a generally U-shaped bracket conforming to the shape of the track and having inward-facing flanges 19a that may be snapped onto an inverted T-bar.

In FIG. 12 the third preferred embodiment 21 of the invention having a rectangular cross section is shown having an attachment means 29 supporting the track from an inverted T-bar ceiling runner 20. The attachment means is a also generally U-shaped bracket conforming to the shape of the track and having inward-facing flanges 29a that may be snapped onto an inverted T-bar.

In FIG. 13 the photometry for a tracklight according to the present invention shows relative longitudinal intensity for placement of light sources along the length of the track. By installing the light sources uniformly spaced along the track, uniform illumination 41 along the track can be achieved. By concentrating more light sources near the center of the track length, the track will be longitudinally biased to produce higher intensity in the center, with dimmer ends 42. By concentrating more light sources near the ends of the track, more illumination will be longitudinally biased towards the ends, with the center being dimmer 43. And by concentrating more light sources at one end of the track, the illumination will be biased to be brightest at that end, diminishing to the opposite end 44 in proportion to the light source density.

### SUMMARY, RAMIFICATIONS AND SCOPE

The primary purpose of the present invention is achieved and in practice provides an elongated tracklight system having smooth, uniform horizontal light distribution, and a smoothly graduated vertical light distribution without scallops or discontinuities in the light pattern. The preferred embodiment of the tracklight system of the invention has a very small cross-section of no more than 1-inch that is easily hidden in a narrow recess or surface-mounted behind a small decorative molding. It also can be attached to the 1-inch-wide flange of a standard suspended ceiling T-bar runner. Although the small size of an inch or less in cross section is an important advantage in many applications, the principles herein can easily be enlarged to use large diameter optical fibers or one or more standard (T-2, T-5 or T-8) fluorescent lamps, having diameters of 1/4-inch, 1/2-inch or 1 inch, respectively, within a 2-inch or even larger track cross section dimensions.

1. A tracklight (1, 11, 21) in the form of an elongated tube (2, 22, 32) including:
a) a reflector (4, 14, 24) extending along the length of said tube and having angularly disposed portions proximally joined at an apex on an optical axis of symmetry, said angularly disposed portions having distal edges;
b) a diffuser (5, 15, 25) extending for the length of said tube and having angularly disposed proximal portions terminating in distal edges engaged with the reflector;
c) a lens (7, 17, 27) extending between the distal edges of the diffuser, and separating the reflector from the diffuser; and
d) one or more light sources (8) positionable along the length of the tube between the reflector and lens, emitting light through the lens and diffuser, generally perpendicular to the length of the tube.

2. A tracklight according to claim 1 in which the reflector forms a right angle about the apex and the diffuser also forms a right triangle in which the lens is the hypotenuse, whereby the elongated tube is a square or rectangle having two reflective sides and two light transmitting sides that emit light generally perpendicular to the length of the tube.

3. A tracklight according to claim 1 in which the reflector portions are generally arcuate, the diffuser is an arcuate segment, and the lens forms a chord of said diffuser, whereby the elongated tube is a circle or ellipse having a reflective side and a light transmitting side that emits light generally perpendicular to the length of the tube.

4. A tracklight according to claim 1, 2 or 3 in which the lens includes linear prisms biasing transverse light away from or collimated along the plane of a symmetric centerline.

5. A tracklight according to claim 4 in which the biasing lens prisms are reversible.

6. A tracklight according to claim 1, 2 or 3 in which the lens and diffuser form a single clear plastic extrusion.

7. A tracklight according to claim 1, 2 or 3 in which the lens includes lightdiffusing means.

8. A tracklight according to claim 1, 2 or 3 in which the light source (8) is one or more fiber optic light guides receiving light from a remote source and comprising side-emitting optical fibers (8s) or end-emitting fibers having diagonal tips (8d) or conical tips (8c) producing side-emitted light.

9. A tracklight according to claim 8 in which the light guides lights are secured in a proximal end 3p of the tube and extend towards the distal end, or secured at a central point and extend towards both ends.

10. A tracklight according to claim 1, 2 or 3 in which the light sources are side-emitting lamps, including incandescent, fluorescent, metal halide or light-emitting diodes.

11. An elongated tracklight system (1, 11, 21) in the form of a tube (2, 22, 32) comprising a light reflector and a light diffuser, said tube enclosing one or more longitudinally-spaced light sources (8, 8a, 8b) emitting light through an elongated lens 7 within the tube, said lens including means 7a, 17a, 27a for biasing light in at least one selected radial direction in a plane transverse to the tube.

12. A tracklight according to claim 11 in which the lens and diffuser are integral.

13. A tracklight according to claim 11 in which the lens is reversible to change the direction of desired light biasing.

14. A tracklight according to claim 11 in which the light sources are longitudinally movable to vary the relative light intensity at one or more selected longitudinal locations along the tube.
